(19) United States
(12) Patent Application Publication
(10) Pub. No.: US 2013/0185581 A1
(43) Pub. Date: Jul. 18, 2013

(54) Efficient Code Dispatch Based on Performance and Energy Consumption

(71) Applicants: Gerald Paul Michalak, Cary, NC (US); Fredrick Joseph Bontemps, Cary, NC (US)

(72) Inventors: Gerald Paul Michalak, Cary, NC (US); Fredrick Joseph Bontemps, Cary, NC (US)

(73) Assignee: QUALCOMM INCORPORATED, San Diego, CA (US)

(21) Appl. No.: 13/352,670

(22) Filed: Jan. 18, 2012

(51) Int. Cl. G06F 1/26

(52) U.S. Cl. 713/340; 713/300

(57) ABSTRACT

A multiplexer selects one of a plurality of sense outputs from sensing circuits. Each of the sensing circuits is located in a corresponding one of voltage regulators supplying power to processors in a subsystem. The corresponding one of voltage regulators is associated with one of processors. An analog-to-digital converter converts the selected one of the plurality of sense outputs to a digital parameter representing energy consumption of the one of the processors associated with the corresponding one of the voltage regulators. The energy consumption is used for dispatching dynamically generated code.

### FIELD OF DISCLOSURE

The presently disclosed embodiments are directed to the field of code assignments, and more specifically, to code dispatch.

### BACKGROUND

Recently, technologies for portable code that target multiple processor environments have evolved in capability and popularity. Examples of code portability include virtual machines, dynamic binary translators and multi-processor languages. Among various techniques, assignment of code in a software execution environment has become a challenge for designers. The problem is difficult mainly due to the existence of multiple processors on a system-on-chip (SoC) architecture. The multiple processors typically have architectures that are optimally designed to perform specific functions or a set of specialized functions to provide various functionalities to the system. For example, a mobile device may include a graphic functionality to support games applications, an imaging functionality to display video or images, an audio functionality to provide music or speech processing, etc. For a well defined application with clear requirements, it is relatively not difficult to select the proper processor for execution. However, when there are features in an application which encompass various architectures, it is sometimes difficult to determine a suitable processor for execution. The problem is particularly troublesome for real-time applications with dynamically generated codes. For many advanced platforms, especially mobile devices, the availability of various processors has created a challenging design problem in efficiently dispatching a dynamically generated code to a proper processor in a multiprocessor environment while minimizing the energy consumption of the processors.

### SUMMARY

Exemplary embodiments of the invention are directed to systems and method for efficient code dispatching. A multiplexer selects one of a plurality of sense outputs from sensing circuits. Each of the sensing circuits is located in a corresponding one of voltage regulators supplying power to processors in a subsystem. The corresponding one of the voltage regulators is associated with one of the processors. An analog-to-digital converter converts the selected one of the plurality of sense outputs to a digital parameter representing energy consumption of the one of the processors associated with the corresponding one of the voltage regulators. The energy consumption is used for dispatching a dynamically generated code.

### BRIEF DESCRIPTION OF THE DRAWINGS

The accompanying drawings are presented to aid in the description of embodiments of the invention and are provided solely for illustration of the embodiments and not limitation thereof.

FIG. 1 is a diagram illustrating an environment in which one embodiment of the invention may be practiced.

FIG. 2 is a diagram illustrating a subsystem according to one embodiment.

FIG. 3 is a diagram illustrating a sensing circuit according to one embodiment.

FIG. 4 is a diagram illustrating a controller according to one embodiment.

FIG. 5 is a flowchart illustrating a process to perform efficient code dispatching according to one embodiment.

FIG. 6 is a flowchart illustrating a process to perform selecting one of plurality of sense outputs according to one embodiment.

FIG. 7 is a flowchart illustrating a process to perform efficient code dispatching according to one embodiment.

FIG. 8 is a flowchart illustrating a process to perform obtaining energy consumption according to one embodiment.

FIG. 9 is a diagram illustrating a controller according to one embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

Embodiments of the invention may be directed to systems and method for efficient code dispatching based on performance and energy consumption for portable and dynamically generated code on mobile devices. The technique provides an integrated, dynamic power measurement capability built into multiple voltage regulators that provide power to multiple processors in a system. Each of the voltage regulators is enhanced by a sense circuit. A multiplexer selects one of a plurality of sense outputs from sensing circuits. Each of the sensing circuits is located in a corresponding one of voltage regulators supplying power to processors in a subsystem. The corresponding one of voltage regulators is associated with one of processors. An analog-to-digital converter converts the selected one of the plurality of sense outputs to a digital parameter representing energy consumption of the one of the processors associated with the corresponding one of the voltage regulators. Using the measurements of the voltage and/or current provided by the sense circuits, energy consumption by each of the processors when executing a dynamically generated code may be calculated. From this information, the code may be assigned to a processor to satisfy an optimality criterion or criteria for an efficient code dispatching.

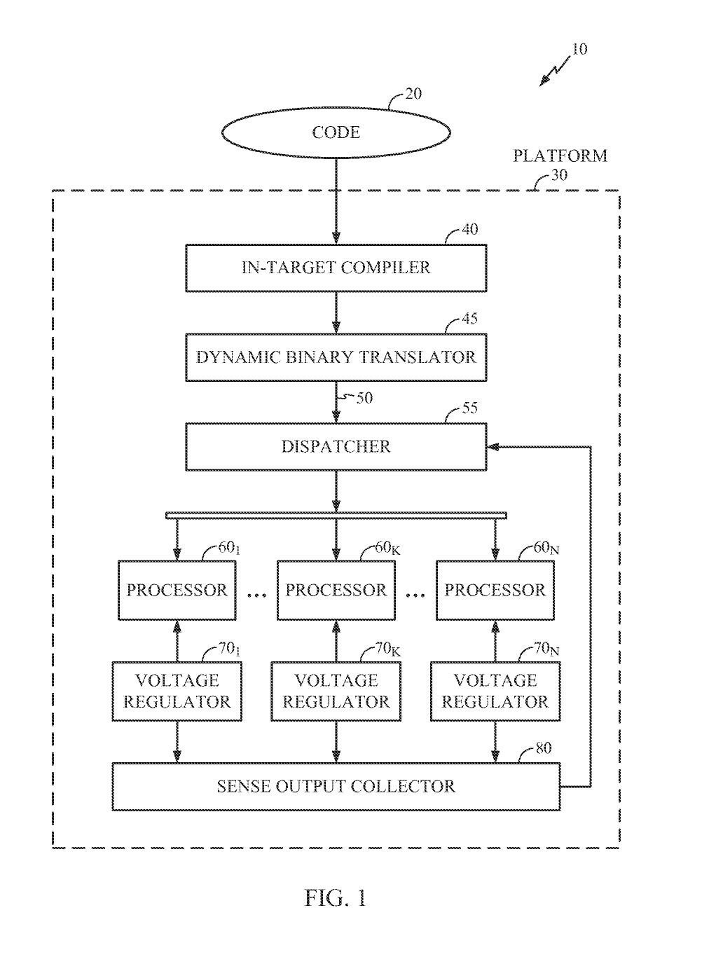

FIG. 1 is a diagram illustrating an environment 10 in which one embodiment of the invention may be practiced. The environment 10 may include both hardware and software components. It may include a code 20 and a platform 30. The environment 10 may include more or less components than the components shown in FIG. 1.

The code 20 may be an application, a program, a set of instructions, or a software module. It may be portable in that it may be executed in any environment with proper interface and software support. In one embodiment, it may be downloadable from a network (e.g., the Internet). The code 20 may be a system utility, an entertainment application (e.g., games), a media application (e.g., audio, video, imaging, graphics), a finance application (e.g., stocks), a news application, etc. Depending on the application, the execution of the code 20 may be optimal or efficient if it is executed by an appropriate processor. For example, a media application may be most efficiently executed by a digital signal processor (DSP), a game application may be most appropriately executed by a graphics processing unit (GPU) processor. For real-time applications where response time is comparable to user's experience or interactions, it is useful for the code 20 to be executed efficiently by an appropriate processor.

The platform 30 may represent any platform that executes the code 20. It may be a mobile platform, a desktop platform, a network-intensive platform, etc. In one embodiment, the platform 30 is a multiprocessor platform in which a number of processors are used to execute various applications which include the code 20. The platform 30 may include an in-target compiler 40, a dynamic binary translator 45, a dispatcher 55, N processors 60ₖ with k=1, . . . , N, N voltage regulators 70ₖ with k=1, . . . , N, and a sense output collector 80. The platform 30 may include more or less than the above components.

The in-target compiler 40 compiles the code 20. It typically translates the source program of the code 20 into an executable code. The dynamic binary translator 45 may be a program or a module to translate the executable code as compiled by the in-target compiler 40 to an executable code of the underlying architecture at run time. It generates a dynamically generated code 50. The dispatcher 55 dispatches the dynamically translated executable code 50 to the assigned processor for execution. The dispatcher 55 performs its function dynamically using the results provided by the sense output collector 80.

The processors 60ₖ {k=1, . . . , N} (also denoted as 60_{1:N}) may represent any processors utilized by the platform 30. They may include a general-purpose central processing unit (CPU), a graphics processing unit (GPU), a digital signal processor (DSP), a media processor, a network processor, a storage processor, or any processor with architecture optimized for a specific function. The voltage regulators 70ₖ {k=1, . . . , N} (also denoted as 70_{1:N}) provide regulated power to the corresponding processors 60ₖ {k=1, . . . , N}. In one embodiment, each of the voltage regulators 70ₖ {k=1, . . . , N} incorporates in-circuit sensing circuits to provide sensed voltage or current that is being supplied to the corresponding processor. The sense output collector 80 collects the sense outputs as provided by the sensing circuits in the voltage regulators 70ₖ {k=1, . . . , N} and supplies this information to the dispatcher 55.

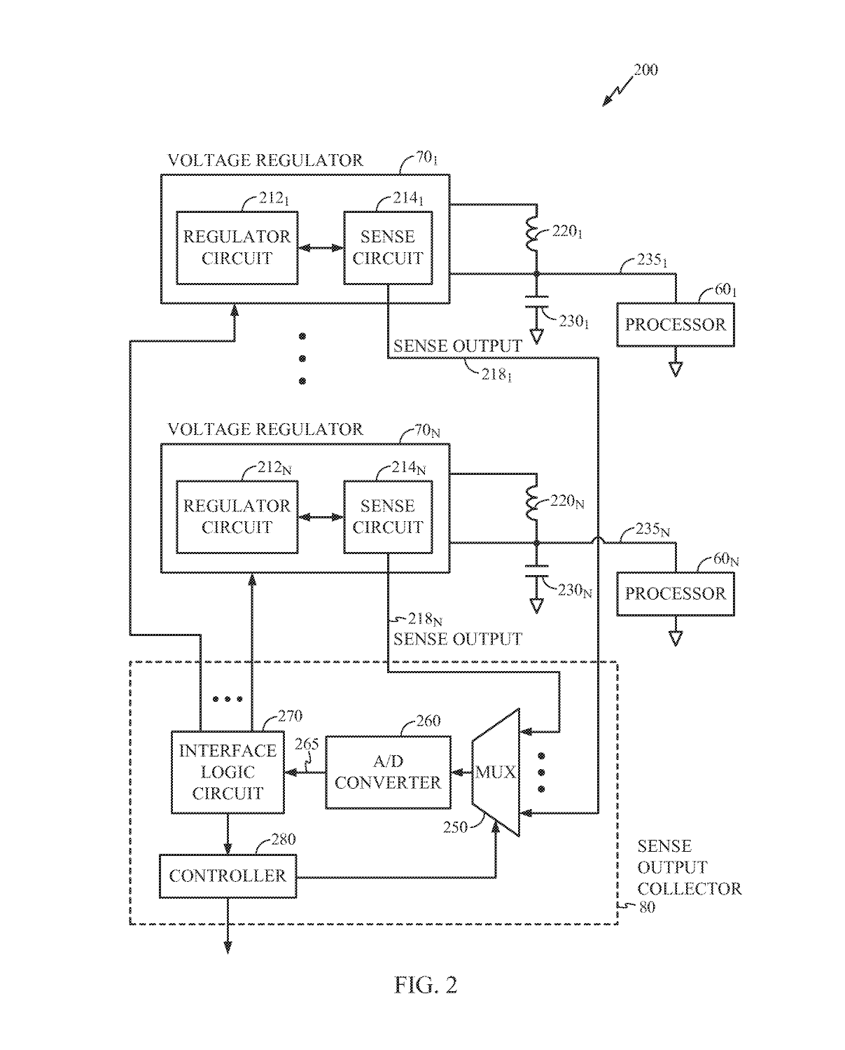

FIG. 2 is a diagram illustrating a subsystem 200 according to one embodiment. The subsystem 200 may encompass the components as described earlier. It may include N voltage regulators 70ₖ {k=1, . . . , N} and the sense output collector 80. Typically, the N voltage regulators 70_{1:N} contain the same components or components that perform similar or equivalent functionalities. For clarity, only one of the N voltage regulators 70_{1:N} will be described and the following description uses the subscript k where k=1, . . . , N.

The voltage regulator 70ₖ supplies power to the corresponding processor 60ₖ in the subsystem 200. It provides a regulated supply voltage or power 235ₖ to the corresponding processor 60ₖ. It may have external circuitry which includes an inductor 220ₖ and a capacitor 230ₖ. The inductor 220ₖ and the capacitor 230ₖ form a filter to filter the output voltage. The values of the inductance of inductor 220ₖ and the capacitance of capacitor 230ₖ depend on the amount of desired filtering. The voltage regulator 70ₖ may include a regulator circuit 212ₖ and a sense circuit 214ₖ. The regulator circuit 212ₖ represents a typical regulator circuit or existing regulator circuit. It may be a switching voltage regulator or a linear voltage regulator. The switching voltage regulator may be a step-down (e.g., a buck converter) switching regulator, or a step-up (e.g., a buck-boost converter) switching regulator. The sense circuit 214ₖ provides a sense output 218ₖ to the sense output collector $0. Each of the sensing circuits 214ₖ {k=1, . . . , N} (also denoted as 214_{1:N}) is located in a corresponding one of the voltage regulators 70ₖ {k=1, . . . , N} associated with one of the processors 60ₖ {k=1, . . . , N}. The sense output 218ₖ may include a sense signal or multiple signals representing multiple parameters being measured or sensed. In one embodiment, the sense output 218ₖ includes a voltage signal and a current signal which represents the voltage and the current, respectively, being supplied to the corresponding processor 60ₖ. The sense circuit 214ₖ is an add-on or additional circuit added to the existing regulator circuit 212ₖ. It typically does not require a re-design or modification on the regulator circuit 212ₖ. In addition, it may be constructed with small sized components.

The sense output collector 80 collects the sense outputs 218ₖ{k=1, . . . , N} (also denoted as 218_{1:N}) and forwards the results to the dispatcher 55 (FIG. 1). It may include a multiplexer 250, and analog-to-digital converter (ADC) 260, an interface logic circuit 270, and a controller 280. The sense output collector 80 may include more or less components than the above components.

The multiplexer 250 may select one of a plurality of sense outputs 218ₖ {k=1, . . . , N} from the sensing circuits 214ₖ {k=1, . . . , N}. The multiplexer 250 may be an analog data selector or a data steering circuit that transfers one of the sense outputs 218ₖ {k=1, . . . , N} to the ADC 260 according to a selector control signal from the controller 280. The ADC 260 is coupled to the multiplexer 250 to convert the selected one of the plurality of sense outputs 218ₖ{k=1, . . . , N} to a digital parameter 265 representing the energy consumption of the one of the processors 60ₖ {k=1, . . . , N} associated with the corresponding one of the voltage regulators 70ₖ{k=1, . . . . , N}. The digital parameter may be a digital word that represents the value of the selected sense output 218ₖ. The word length may be determined according to the desired accuracy. For example, it may range from 8-hit to 16-bit. The interface logic circuit 270 provides the bus interface to other devices which may include parallel-to-serial converter, level converter, or any other interface functionalities to transform the digital parameter into a quantity that is compatible with the controller 280 and other communication and processing requirements. The interface logic circuit 270 may also provide input or control signals to the voltage regulators 70ₖ {k=1, . . . , N} to configure the voltage regulators 70ₖ {k=1, . . . , N} in appropriate operational modes.

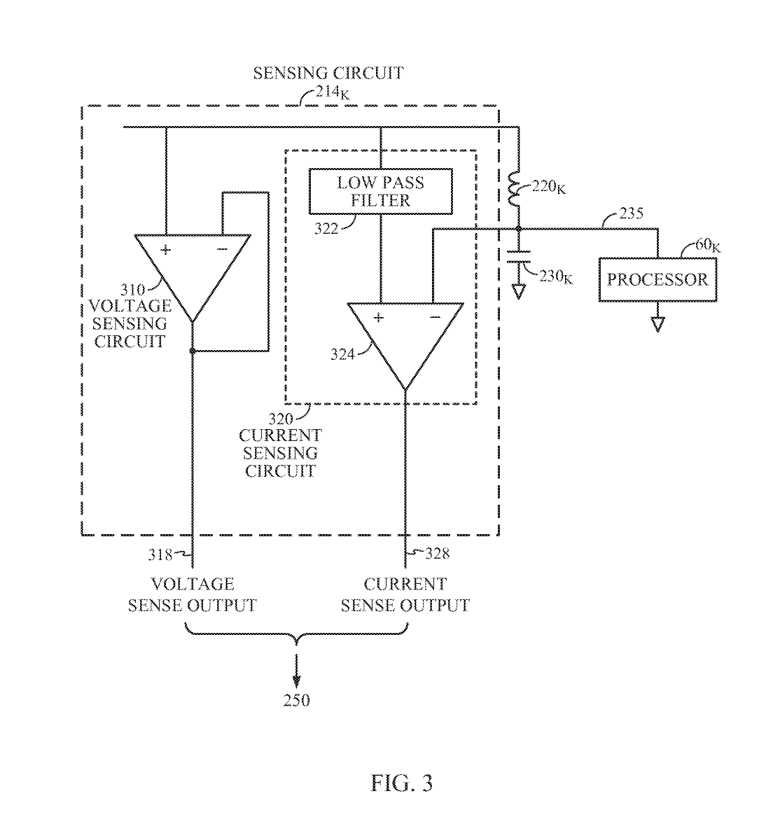

FIG. 3 is a diagram illustrating the sensing circuit 214ₖ shown in FIG. 2 according to one embodiment. The sensing circuit 214ₖ may represent any of the sensing circuits 214ₖ{k=1, . . . , N} shown in FIG. 2. The sensing circuit 214ₖ may include a voltage sensing circuit 310 and a current sensing circuit 320. The sensing circuit 214ₖ may include more or less components than the above components.

The voltage sensing circuit 310 may sense the regulated voltage output 235 of the voltage regulator 70ₖ (FIG. 2) through the inductor 220ₖ. It may include a gain or buffer amplifier with a fixed gain or a programmable gain to provide a voltage sense output 318.

The current sensing circuit 320 may sense current of the regulated voltage output 235 of the voltage regulator 70ₖ. It may generate a current sense output 328. It may be implemented by a number of methods. For a current sensing in switched mode power management, it may be implemented by: (1) inductor voltage drop sensing with an integrated low-pass filter, (2) inductor voltage drop sensing with an external low-pass filter, or (3) a pass transistor (e.g., field effect transistor) sensing of drain-to-source voltage during on time. For a current sensing in linear low drop-out regulators, it may be implemented by a fractional current mirror circuit. In one embodiment, it may include a low-pass filter 322 and an amplifier 324. The low-pass filter 322 filters the voltage drop across the inductor 220ₖ to eliminate high frequency components such as noise or current spikes. The low-pass filter 322 may be internal or external to the voltage regulator 70ₖ. The amplifier 324 may be a buffer amplifier that performs voltage-to-current conversion to provide a quantity that is proportional to the current.

The voltage sense output 318 and the current sense output 328 may form the sense output 218ₖ to the multiplexer 250. Depending on the requirements, one of them or both of them are used as the sense output 218ₖ. Additional sensing circuits may also be employed to provide additional measurements. The sense output 218ₖ therefore represents the power or energy as consumed by the corresponding processor 70ₖ at any particular instant or over a predetermined time interval.

The extra circuitry added to the existing regulators may occupy a very small area. The buffer amplifiers and the ADC 260 may be constructed to have very small areas. For example, the size of the ADC 260 may be less than 1 mm², depending on the architecture and process technology of data conversion.

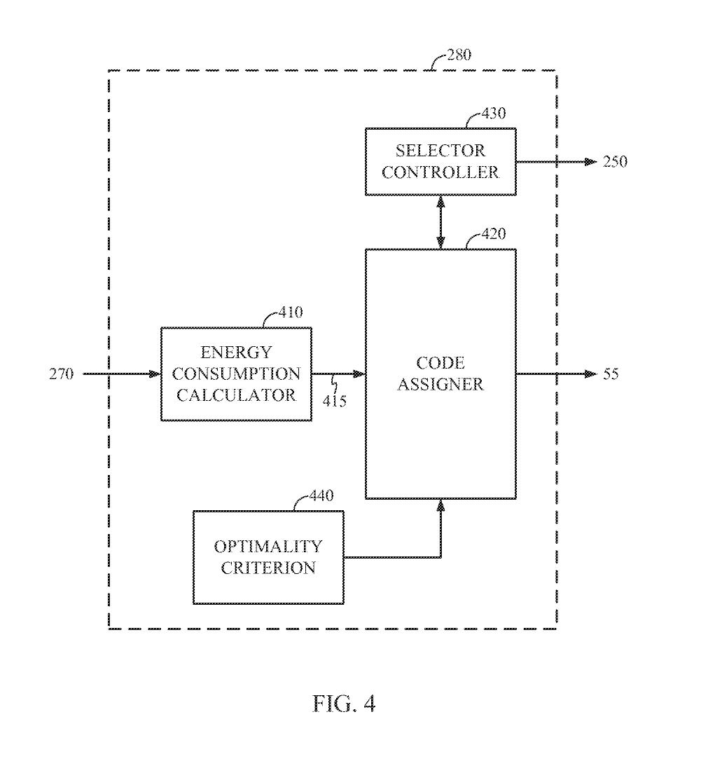

FIG. 4 is a diagram illustrating the controller 280 shown in FIG. 2 according to one embodiment. The controller 280 may be a dedicated controller or it may be part of the central processing unit used in the platform 30. It may include circuitry and/or software modules to perform the control and monitor functions. It may include an energy consumption calculator 410, a code assigner 420, and a selector controller 430. The controller 280 may include more or less components than the above components and any of the above components may be implemented by hardware, software, firmware, or any of their combinations.

The energy consumption calculator 410 may compute the energy or power as consumed by the corresponding processor 60ₖ based on the sense output 218ₖ as converted by the ADC 260 and processed by the interface logic circuit 270, and outputs the result 415. For example, it may compute the power as a product of the voltage sense output 318 and current sense output 328. It may compute the instantaneous power or an integrated or average power that is determined over a predetermined time interval. The energy consumption may be further normalized according to a normalization factor so that comparison of various energy consumptions by the processors 60ₖ {k=1, . . . , N} may be properly interpreted. This normalization may take into account factors such as operational mode (e.g., standby, low-power, full operation) of the platform 30, size of the dynamically generated code 50, etc.

The code assigner 420 may assign the dynamically generated code 50 to appropriate processor 60ₖ using an optimality criterion or criteria 440. The optimality criterion 440 may be based on the overall or individual power consumption, the execution time, the amount of memory that is allocated to a processor. It may be a combination of multiple parameters representing these performance factors. The code assigner 420 may accumulate the readings of the energy consumption over some period of time. It may also store the readings for one processor or more than one processor. An assignment procedure may be carried out using the stored information to maximize the optimality criterion 440. The result of the assignment is the determination of a processor that is best suited for the dynamically generated code 50 under the optimality criterion 440. The code assigner 420 may forward the assignment result or results to the code dispatcher 55 to dispatch the dynamically generated code 50 to the assigned processor. All or part of the functionalities of the code assigner 420 may be integrated into the dispatcher 55.

The selector controller 430 provides control signal to control the multiplexer 250 to select the desired sense output. The code assigner 420 may control the selector controller 430 to select the sense outputs for an instantaneous reading or readings over a time interval. The energy consumption therefore may be calculated as an instantaneous energy consumption or an average energy consumption.

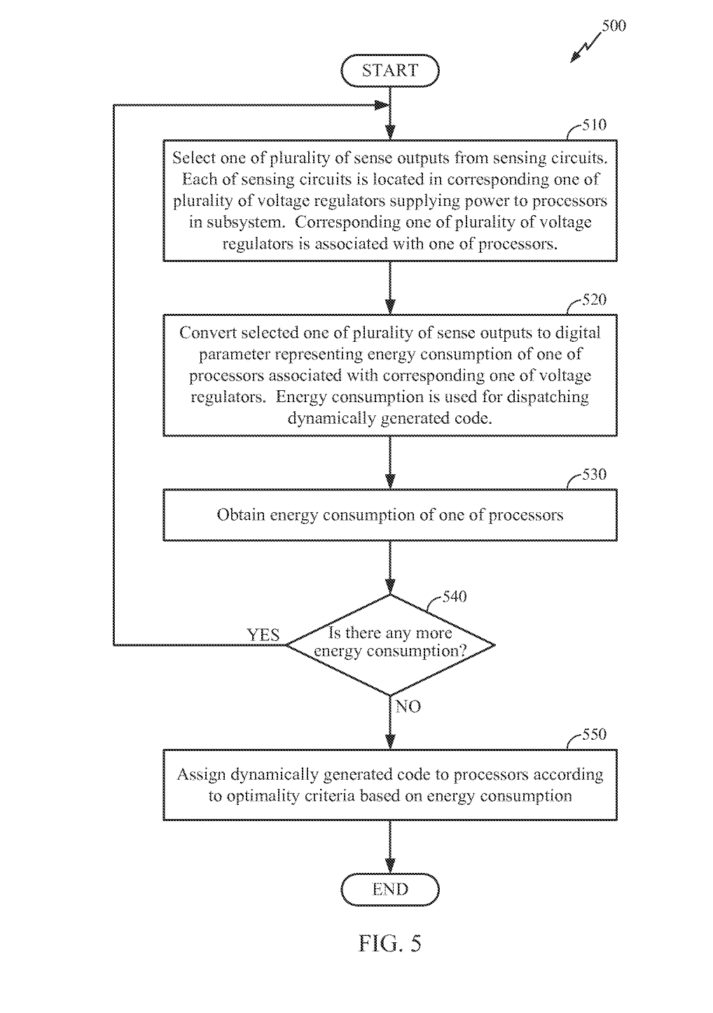

FIG. 5 is a flowchart illustrating a process 500 to perform efficient code dispatching according to one embodiment.

Upon START, the process 500 selects one of a plurality of sense outputs from sensing circuits (Block 510). Each of the sensing circuits is located in a corresponding one of a plurality of voltage regulators supplying power to processors in a subsystem. The corresponding one of the plurality of voltage regulators is associated with one of the processors. Next, the process 500 converts the selected one of the plurality of sense outputs to a digital parameter representing energy consumption of the one of the processors associated with the corresponding one of the voltage regulators (Block 520). Then, the process 500 obtains the energy consumption of the one of the processors (Block 530). This may be performed by calculating the power consumption and normalizing the calculated power consumption by a nomialization factor. The energy consumption is used for dispatching a dynamically generated code.

Next, the process 500 determines if there is any more energy consumption that needs to be obtained (Block 540). If so, the process 500 returns to Block 510 to select another sense output. Otherwise, the process 500 assigns the dynamically generated code or codes to the processors according to an optimality criterion based on the energy consumption (Block 550). The process 500 is then terminated.

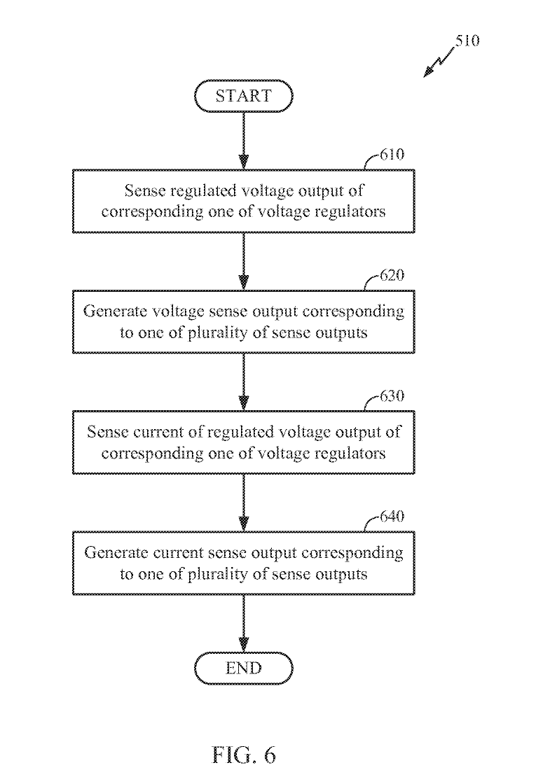

FIG. 6 is a flowchart illustrating the process 510 shown in FIG. 5 to perform selecting one of a plurality of sense outputs according to one embodiment.

Upon START, the process 510 senses a regulated voltage output of the corresponding one of the voltage regulators (Block 610). Next, the process 510 generates a voltage sense output corresponding to the one of the plurality of sense outputs (Block 620). Then, the process 510 senses a current of the regulated voltage output of the corresponding one of the voltage regulators (Block 630). This may be performed by a number of methods. One method includes filtering the regulated voltage output, sensing a voltage drop across an inductor, and converting the sensed voltage drop across the inductor to the current sense output. Another method includes sensing drain-to-source voltage during an ON time and generating the current sense output from the sensed drain-to-source voltage. Another method is mirroring a fractional current. Next, the process 510 generates a current sense output corresponding to the one of the plurality of sense outputs (Block 640). The process 510 is then terminated.

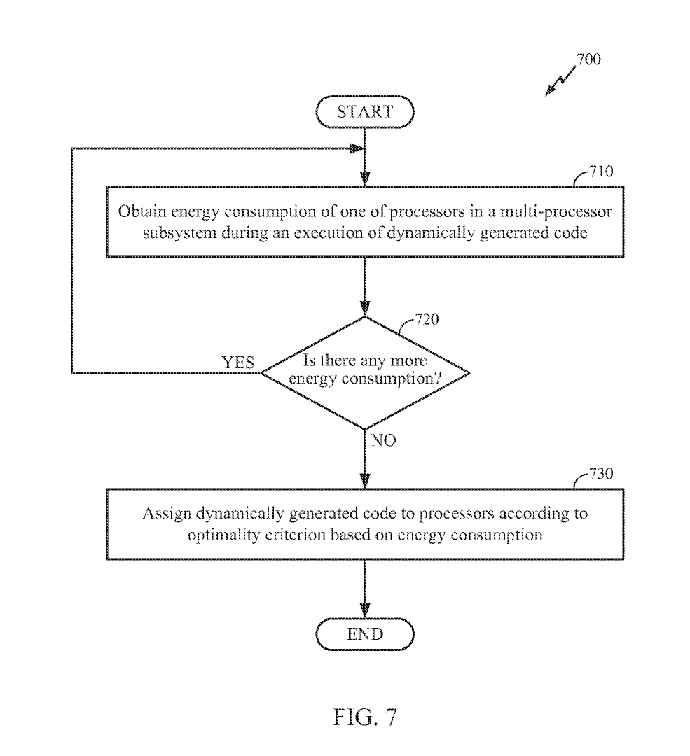

FIG. 7 is a flowchart illustrating a process 700 to perform efficient code dispatching according to one embodiment.

Upon START, the process 700 obtains energy consumption of one of the processors in a multi-processor subsystem during an execution of a dynamically generated code (Block 710). Next, the process 700 determines if there is any more energy consumption that needs to be obtained (Block 720). If so, the process 700 returns to Block 710 to obtain energy consumption of another processor. Otherwise, the process 700 assigns the dynamically generated code to the processors according to an optimality criterion based on the energy consumption (Block 730). The process 700 is then terminated.

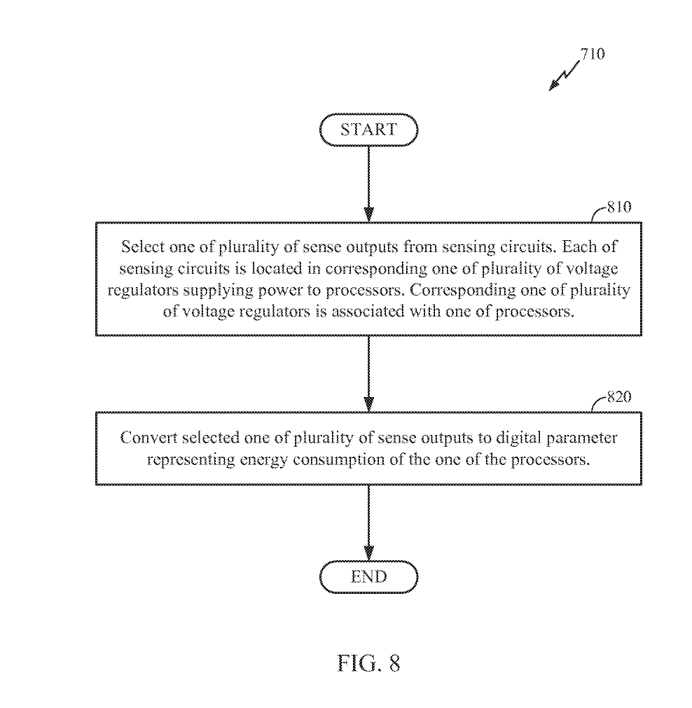

FIG. 8 is a flowchart illustrating the process 710 shown in FIG. 7 to perform obtaining energy consumption according to one embodiment.

Upon START, the process 710 selects one of a plurality of sense outputs from sensing circuits (Block 810). Each of the sensing circuits is located in a corresponding one of a plurality of voltage regulators supplying power to the processors. The corresponding one of the plurality of voltage regulators is associated with one of the processors. The sensing circuits may be constructed as described above. Next, the process 710 converts the selected one of the plurality of sense outputs to a digital parameter representing the energy consumption of the one of the processors (Block 820). The process 710 is then terminated.

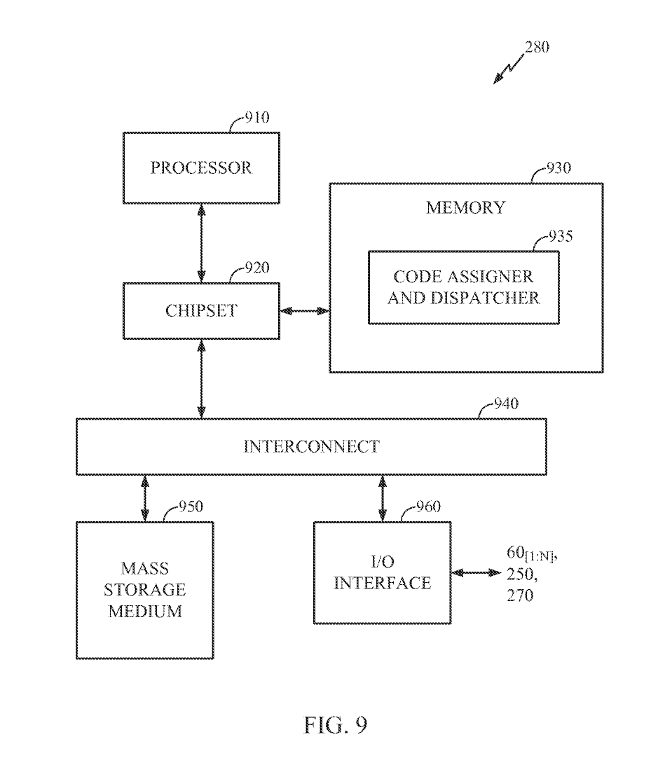

FIG. 9 is a diagram illustrating a controller 280 shown in FIG. 2 according to one embodiment. The controller 280 includes a processor 910, a chipset 920, a memory 930, an interconnect 940, a mass storage medium 950, an input/output (I/O) interface 960. The controller 280 may include more or less components than the above components.

The processor 910 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The chipset 920 provides control and configuration of memory and input/output devices such as the memory 930, the mass storage medium 950 and the I/O interface 960. The chipset 920 may integrate multiple functionalities such as graphics, media, host-to-peripheral bus interface, memory control, power management, etc. It may also include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DM 1), etc.

The memory 930 stores code and data. The memory 930 is typically implemented with dynamic random access memory (DRAM), static random access memory (SRAM), or any other types of memories including those that do not need to be refreshed. The memory 930 may include a code assigner and dispatcher module 935 that performs all or portion of the operations described above.

The interconnect 940 provides interface to peripheral devices. The interconnect 940 may be point-to-point or connected to multiple devices. For clarity, not all interconnects are shown. It is contemplated that the interconnect 940 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage medium 950 includes interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet interface (ATAPI), etc. The mass storage device may include compact disk (CD) read-only memory (ROM), digital video/versatile disc (DVD), floppy drive, hard drive, tape drive, and any other magnetic or optic storage devices. The mass storage device provides a mechanism to read machine-accessible media. In one embodiment, the mass storage medium 950 may include flash memory.

The I/O interface 960 provides interface to I/O devices such as the panel display or the input entry devices. The I/O interface 960 may provide interface to a touch screen in the graphics display, the keypad, a d other communication or imaging devices such as camera, Bluetooth interface, etc.

The word “exemplary” is used herein to mean “serving as an example, instance, or illustration,” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation. The “processor-readable or accessible medium” or “machine-readable or accessible medium” may include any medium that may store or transfer information. Examples of the processor-readable or machine-accessible storage medium include an electronic circuit, a semiconductor memory device, a read only memory (ROM), a flash memory, an erasable programmable ROM (EPROM), a floppy diskette, a compact disk (CD) ROM, an optical disk, a hard disk, etc. The machine-accessible storage medium may be embodied in an article of manufacture. The machine-accessible storage medium may include information or data that, when accessed by a machine, cause the machine to perform the operations or actions described above. The machine-accessible storage medium may also include program code, instruction or instructions embedded therein. The program code may include machine-readable code, instruction or instructions to perform the operations or actions described above. The term “information” or “data” here refers to any type of information that is encoded for machine-readable purposes. Therefore, it may include program, code, data, file, etc.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Further, all or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer-readable media embodying a method for efficient code dispatching. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly, stated.

What is claimed is:

1. An apparatus comprising:
a multiplexer coupled to a plurality of voltage regulators supplying power to processors in a subsystem to select one of a plurality of sense outputs from sensing circuits, each of the sensing circuits being located in a corresponding one of the voltage regulators associated with one of the processors; and
an analog-to-digital converter coupled to the multiplexer to convert the selected one of the plurality of sense outputs to a digital parameter representing energy consumption of the one of the processors associated with the corresponding one of the voltage regulators, the energy consumption being used for dispatching a dynamically generated code.

2. The apparatus of claim 1 wherein each of the sensing circuit comprises:
a voltage sensing circuit to sense a regulated voltage output of the corresponding one of the voltage regulators, the voltage sensing circuit generating a voltage sense output corresponding to one of the plurality of sense outputs.

3. The apparatus of claim 2 wherein each of the sensing circuit further comprises:
a current sensing circuit to sense a regulated current output of the corresponding one of the voltage regulators, the current sensing circuit generating a current sense output corresponding to the one of the plurality of sense outputs.

4. The apparatus of claim 3 wherein the current sensing circuit comprises:
a low-pass filter to filter the regulated voltage output; and
an inductor drop sensor coupled to the low-pass filter to sense a voltage drop across an inductor, the inductor drop sensor converting the sensed voltage drop across the inductor to the current sense output.

5. The apparatus of claim 3 wherein the current sensing circuit comprises a pass transistor to sense drain-to-source voltage during an on time, the pass transistor generating the current sense output from the sensed drain-to-source voltage.

6. The apparatus of claim 3 wherein the current sensing circuit comprises a fractional current mirror.

7. The apparatus of claim 1 further comprising:
a controller to obtain the energy consumption of the one of the processors, the energy consumption being used to assign the dynamically generated code to the processors according to an optimality criterion.

8. A method comprising:
selecting one of a plurality of sense outputs from sensing circuits, each of the sensing circuits being located in a corresponding one of a plurality of voltage regulators supplying power to processors in a subsystem, the corresponding one of the plurality of voltage regulators being associated with one of the processors; and
converting the selected one of the plurality of sense outputs to a digital parameter representing energy consumption of the one of the processors associated with the corresponding one of the voltage regulators, the energy consumption being used for dispatching of a dynamically generated code.

9. The method of claim 8 wherein selecting comprises:
sensing a regulated voltage output of the corresponding one of the voltage regulators; and
generating a voltage sense output corresponding to the one of the plurality of sense outputs.

10. The method of claim 9 wherein selecting further comprises:
sensing a regulated current output of the corresponding one of the voltage regulators; and
generating a current sense output corresponding to the one of the plurality of sense outputs.

11. The method of claim 10 wherein sensing the regulated current output comprises:
filtering the regulated voltage output;
sensing a voltage drop across an inductor; and
converting the sensed voltage drop across the inductor to the current sense output.

12. The method of claim 10 wherein sensing the regulated current output comprises:
sensing drain-to-source voltage during an on time; and
generating the current sense output from the sensed drain-to-source voltage.

13. The method of claim 10 wherein sensing the regulated current output comprises mirroring a fractional current.

14. The method of claim 8 further comprising:
obtaining the energy consumption of the one of the processors, and
assigning the dynamically generated code to the processors according to an optimality criterion based on the energy consumption.

15. A method comprising:
obtaining energy consumption of one of the processors in a multi-processor subsystem during an execution of a dynamically generated code, and
assigning the dynamically generated code to the processors according to an optimality criterion based on the energy consumption.

16. The method of claim 15 wherein obtaining comprises:
selecting one of a plurality of sense outputs from sensing circuits, each of the sensing circuits being located in a corresponding one of a plurality of voltage regulators supplying power to the processors, the corresponding one of the plurality of voltage regulators associated with one of the processors; and
converting the selected one of the plurality of sense outputs to a digital parameter representing the energy consumption of the one of the processors.

17. An article of manufacture comprising a machine-accessible storage medium including data that, when accessed by a machine, cause the machine to perform operations comprising:
obtaining energy consumption of one of the processors in a multi-processor subsystem during an execution of a dynamically generated code, and
assigning the dynamically generated code to the processors according to an optimality criterion based on the energy consumption.

18. The article of manufacture of claim wherein the data causing the machine to perform obtaining comprises data that, when executed by the machine, cause the machine to perform operations comprising:
selecting one of a plurality of sense outputs from sensing circuits, each of the sensing circuits being located in a corresponding one of a plurality of voltage regulators supplying power to the processors, the corresponding one of the plurality of voltage regulators associated with one of the processors; and
converting the selected one of the plurality of sense outputs to a digital parameter representing the energy consumption of the one of the processors.

19. An apparatus comprising:
means for selecting one of a plurality of sense outputs from sensing circuits, each of the sensing circuits being located in a corresponding one of a plurality of voltage regulators supplying power to processors in a subsystem, the corresponding one of the plurality of voltage regulators associated with one of the processors; and
means for converting the selected one of the plurality of sense outputs to a digital parameter representing energy consumption of the one of the processors associated with the corresponding one of the voltage regulators, the energy consumption being used for dispatching of a dynamically generated code.

20. The apparatus of claim 19 wherein the means for selecting comprises:
means for sensing a regulated voltage output of the corresponding one of the voltage regulators; and
means for generating a voltage sense output corresponding to the one of the plurality of sense outputs.

21. The apparatus of claim 20 wherein the means for selecting further comprises:
means for sensing a regulated current output of the corresponding one of the voltage regulators; and
means for generating a current sense output corresponding to the one of the plurality of sense outputs.

22. The apparatus of claim 21 wherein the means for sensing the regulated current output comprises:
means for filtering the regulated voltage output;
means for sensing a voltage drop across an inductor; and
means for converting the sensed voltage drop across the inductor to the current sense output.

23. The apparatus of claim 21 wherein the means for sensing the regulated current output comprises:
means for sensing drain-to-source voltage during an on time; and
means for generating the current sense output from the sensed drain-to-source voltage.

24. The apparatus of claim 21 wherein the means for sensing the regulated current output comprises means for mirroring a fractional current.

25. The apparatus of claim 19 further comprising:
means for obtaining the energy consumption of the one of the processors, and
means for assigning the dynamically generated code to the processors according to an optimality criterion based on the energy consumption.

26. An apparatus comprising:
means for obtaining energy consumption of one of the processors in a multi-processor subsystem during an execution of a dynamically generated code, and
means for assigning the dynamically generated code to the processors according to an optimality criterion based on the energy consumption.

27. The apparatus of claim 26 wherein the means for obtaining comprises:
means for selecting one of a plurality of sense outputs from sensing circuits, each of the sensing circuits being located in a corresponding one of a plurality of voltage regulators supplying power to the processors, the corresponding one of the plurality of voltage regulators associated with one of the processors; and
means for converting the selected one of the plurality of sense outputs to a digital parameter representing the energy consumption of the one of the processors.
